(19) United States
(12) Patent Application Publication
(10) Pub. No.: US 2015/0302154 A1
(43) Pub. Date: Oct. 22, 2015

(54) POINT-OF-CARE PRICE TRANSPARENCY SYSTEMS AND METHODS

(71) Applicant: Medlio, Inc., Durham, NC (US)

(72) Inventor: David Stanley Brooks, Durham, NC (US)

(21) Appl. No.: 14/691,364

(22) Filed: Apr. 20, 2015

Related U.S. Application Data
(60) Provisional application No. 61/981,383, filed on Apr. 18, 2014.

(51) Int. Cl. G06F 19/00

(52) U.S. Cl. CPC G06F 19/328; G06F 19/322

(57) ABSTRACT

A method can include a patient presenting insurance information to a medical office where he or she is to receive medical care, the medical office confirming a reason for the patient's visit, and the system sending initial patient information directly to the patient's insurance company or to a clearinghouse. The method can further include the insurance company or clearinghouse replying with anticipated remittance advice including an estimate and the medical office presenting the estimate to the patient.

### CROSS-REFERENCE TO RELATED APPLICATION

This application claims the benefit of U.S. Provisional Patent Application Ser. No. 61/981,383, titled POINT-OF-CARE PRICE TRANSPARENCY SYSTEMS AND METHODS and filed on April 18, 2014, the content of which is hereby fully incorporated by reference herein.

### TECHNICAL FIELD

Embodiments of the disclosed technology generally pertain to systems and methods for healthcare transactions.

### BACKGROUND

FIG. 1 is a flowchart illustrating a typical reimbursement process 100 for medical professionals and facilities. When a patient arrives for an appointment, the medical office will capture the patient's health insurance information, including the insurance provider and the member's identification number (e.g., if they didn't already collect this information at the time the appointment was scheduled), as indicated by 102. The office then may or may not confirm the patient's insurance eligibility by using real-time eligibility software (e.g., either standalone, or integrated into their electronic medical record (EMR) or practice management (PM) system), logging into the specific insurance company's provider portal and doing a look-up on the patient in question, or by calling the insurance provider directly, as indicated by 104.

After the patient has been seen, the physician providing care will document the visit or encounter, as indicated by 106. The documentation process typically involves the creation of a “SOAP” note—whereby the provider documents specific information into Subjective and Objective categories, renders an Assessment, and then formulates a care Plan. Based on the level of complexity of the visit, which should be supported by the documentation, the physician will then create a medical claim using a combination of CPT and ICD-9 (soon to transition to ICD-10) codes, which relate to procedures and diagnoses, respectively.

In simple terms, CPT codes (also referred to as procedure codes) are used to specify the work performed. ICD codes (also referred to as diagnosis codes) are used to explain why the work was performed. Insurance companies will typically evaluate the combination of CPT and ICD codes to determine their medical necessity. In other words, did the diagnosis support the specific procedure performed and billed?

In most cases, physicians will document visits at the end of the day. Some may document between patient encounters but, because of the time it takes, most physicians tend to batch their notes at the end of the day.

Once the physician has finished his or her notes and created bills, or claims, for each of their visits, a medical billing specialist may or may not review the documentation and claims created by the physician, e.g., to ensure that all encounters are optimally and accurately coded. When the claims have been sufficiently prepared and reviewed, the physician or organization submits their claims, usually electronically via a clearinghouse which routes the claims to the appropriate insurance companies, as indicated by 108.

Once received, the insurance companies use software, typically adjudication engines, to determine proper reimbursement, as indicated by 110. This calculation takes into consideration four key pieces of information: (1) the contracted rates with the specific billing physician, (2) the specific plan-level benefits of the patient in question, (3) the combination of services provided (CPTs being billed), and (4) any bundling rules the insurance company has established. For instance, it is common practice for an insurance company to deny or discount a procedure performed during the same visit as an annual physical.

Once the claims have been adjudicated, the insurance company will then remit payment to the physician or organization, e.g., via check or electronic funds transfer (EFT), as indicated by 112. If a check is mailed (a practice which is becoming increasingly uncommon), the remittance advice (e.g., the provider's copy of the explanation of benefits, or EOB) is attached directly to the check. If payment is sent via EFT, the insurance company will separately send an electronic remittance advice (ERA) via the clearinghouse to the physician or provider organization for automatic posting in the provider's PM system. Claims that are submitted electronically and paid via EFT generally take about seven business days to process.

Historically, this overall process has worked quite well for fee-for-service claim adjudication and payment because nearly all patients were on some form of a PPO insurance plan or some other type of insurance with a clearly defined patient co-payment responsibility. In other words, the amount patients typically owed was clearly identified and largely fixed, independent of the specific services rendered. As such, the collection process, at least from the perspective of healthcare providers, has always involved two independent processes—collect copayment from the patient, and collect primary payment from the insurance company.

Over the last few years, more and more employers have sought to minimize their financial risk related to employee health benefits. As such, they have increasingly moved from offering PPO-type insurance plans to offering high-deductible health plans (HDHPs).

HDHPs, many of which are characterized as “catastrophic insurance,” require policy-holders to pay 100% of their healthcare costs up to a specified deductible before insurance contributes anything to the cost. Once the deductible has been met, the policy-holder is then required to contribute a co-insurance amount, e.g., 20%, towards any costs that over and above the deductible amount but below the policy-defined maximum out-of-pocket amount. Once the policy-holder has reached the maximum out-of-pocket threshold, the insurance company is then liable for 100% of all additional healthcare costs.

In addition to placing much more of the financial burden for healthcare costs onto the end-consumer, HDHPs have fundamentally changed the reimbursement process for providers. Now, instead of two separate independent processes, patient payments have been directly tied to the insurance claim process.

For example, if a patient has a HDHP and has not yet met their deductible, there is a good chance that he or she may be financially responsible for the full amount of their next visit's costs. Yet, because their physician does not have the ability to perform the necessary adjudication calculation prior to the visit, the physician has no way to explain to the patient the patient's financial responsibility, nor the ability to collect that balance prior to the visit. As a result, physicians and provider organizations will frequently see the patient, collect nothing at time of service, bill the insurance company, and wait for the adjudication to see how much to collect from the patient after the fact.

This creates a huge problem for both the patient, who has no insight to his or her ultimate financial obligation, and the provider, who has no choice but defer collection. By the time the provider realizes what to collect, the probability of successful collection falls precipitously.

### SUMMARY

Embodiments of the disclosed technology are generally directed to various systems and methods for supporting point-of-care price transparency, or up-front cost estimates for healthcare transactions.

### BRIEF DESCRIPTION OF THE DRAWINGS

FIG. 1 is a flowchart illustrating a prior method of processing reimbursement for a patient's appointment at a medical office.

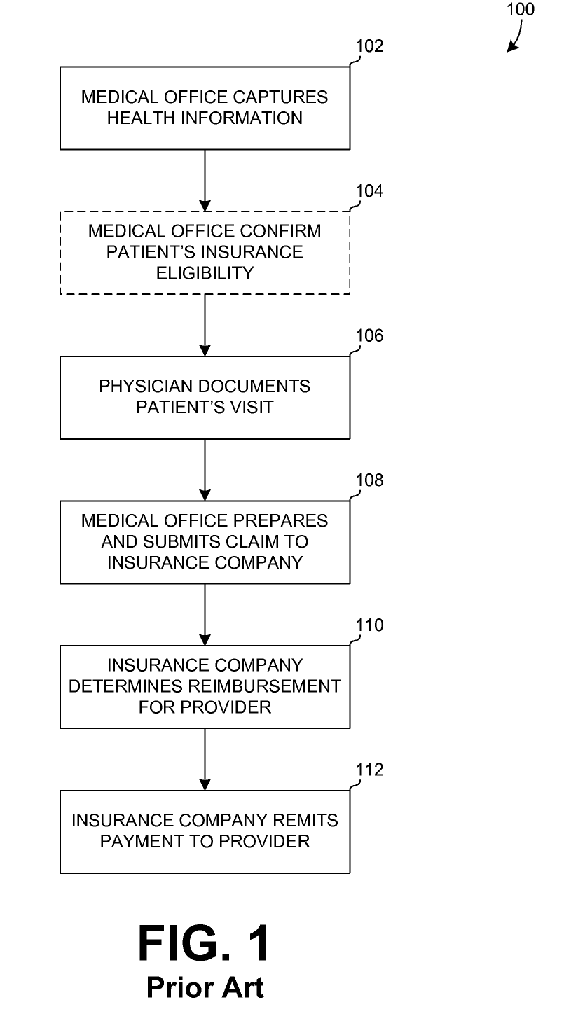

FIG. 2 is a block diagram illustrating an example of a point-of-care transparency system in accordance with certain embodiments of the disclosed technology.

FIG. 3 is a flowchart illustrating a first example of a method of processing payment responsibility information for a patient's appointment at a medical office in accordance with certain embodiments of the disclosed technology.

FIG. 4 is a flowchart illustrating a second example of a method of processing payment responsibility information for a patient's appointment at a medical office in accordance with certain embodiments of the disclosed technology.

FIG. 5 is a flowchart illustrating a third example of a method of processing payment responsibility information for a patient's appointment at a medical office in accordance with certain embodiments of the disclosed technology.

### DETAILED DESCRIPTION

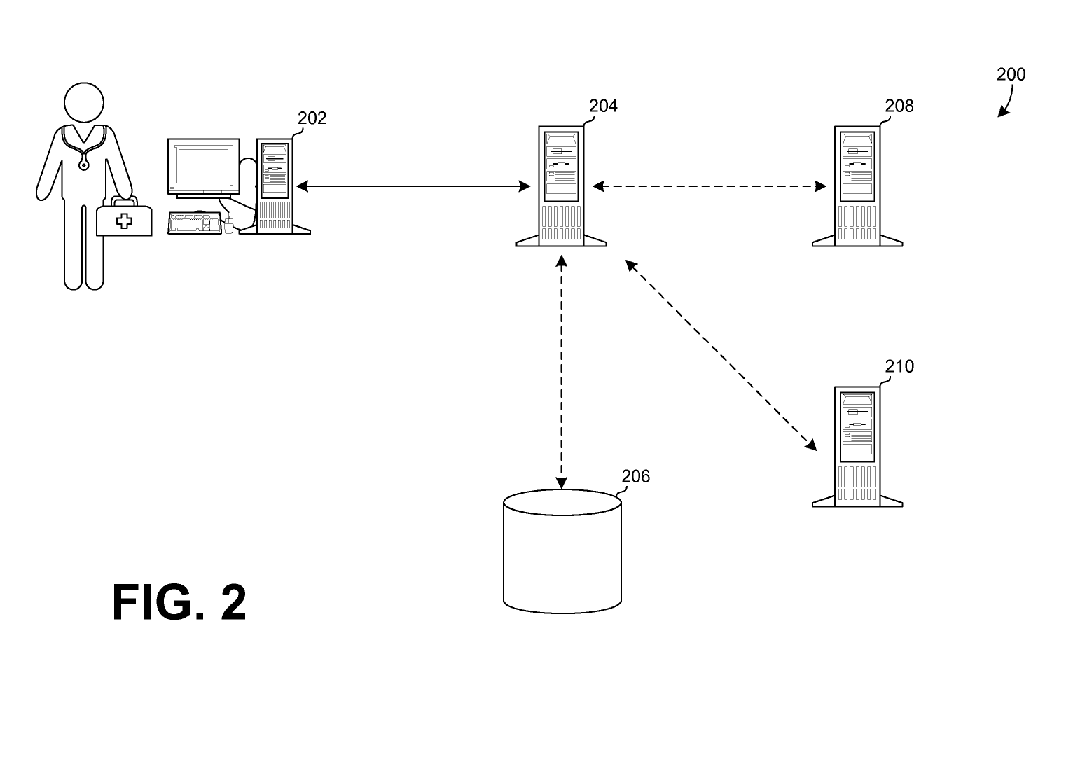

FIG. 2 is a block diagram illustrating an example of a point-of-care transparency system 200 in accordance with certain embodiments of the disclosed technology. In the example, the system 200 includes a medical office computing device 202 configured to communicate with a server 204 or other appropriate computing device configured to run a software application in accordance with certain embodiments of the disclosed technology.

The system 200 also includes an optional database 206 that the server 204 may access, e.g., to access certain stored information pertaining to the patient, the medical office, or both. The system 200 also includes optional other servers 208 and 210 with which the server 204 may communicate. The other servers 208 and 210 may be computing devices at or in connection with one or more insurance companies, for example.

. In certain embodiments, a system (such as the system 200 of FIG. 2) may effectively recreate the insurance adjudication process in order to calculate an expected claim, repricing, and financial responsibility. This solution may involve the use of four pieces of information: (1) the contracted rates between the specific insurance company and the billing physician, (2) the specific plan-level benefits of the patient in question, (3) the combination of services provided (CPTs being billed), and (4) any bundling rules the specific insurance company in question has established.

In such processes, the system may work directly with a specific physician or provider organization to define the contracted rates with the various insurance plans that provider accepts. The provider or organization in question is generally privy to this information and may work with the system to load contract rates into the system, for example.

In order to obtain patient-specific plan level benefits information, the system may use a standard clearinghouse to process 270/271, real-time eligibility request/response transactions. This advantageously allows the system to obtain real-time benefits information on the vast majority of insured patients.

In order to identify the correct bundle of CPT codes prior to an actual visit, the system may evaluate standard billing patterns across all medical specialties. The system may first create standard templates by evaluating millions of historic claims transactions and then fine-tune these templates to reflect the billing habits and patterns of individual organizations and physicians. The system may then tie these bundles directly to the most common “reasons for visit.”

The system may also capture any of a number of bundling rules used by the various insurance companies. These rules may then be applied to the specific bundle being calculated.

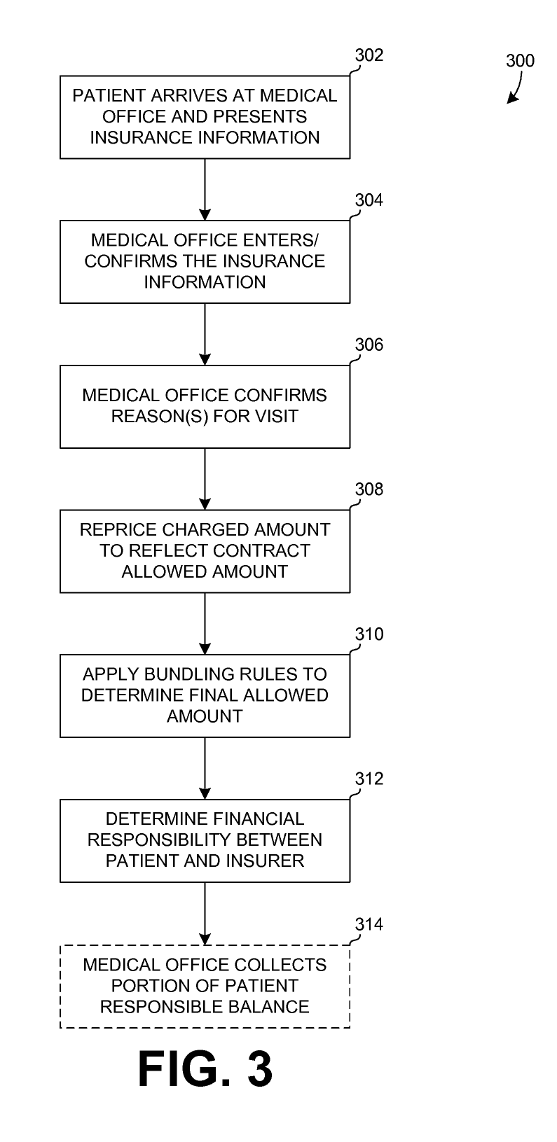

FIG. 3 is a flowchart illustrating a first example 300 of a method of processing payment responsibility information for a patient's appointment at a medical office in accordance with certain embodiments of the disclosed technology. At 302, a patient arrives at a medical office for his or her appointment and presents insurance information to the provider or other office worker or representative. At 304, the medical office either enters or confirms the patient's name, payer, and policy number in the system, which then performs a 270/271 transaction to determine current status and benefits information.

At 306, the office then confirms the reason for the visit, which is tied to the most likely bundle of CPTs to be billed for that encounter. At 308, the system, knowing the contracted rates with the payer in question for that specific office, advantageously reprices the office's charged amount to reflect the contract allowed amount. At 310, the system then applies the bundling rules of the specific payer in question to determine the final allowed amount (e.g., estimate). At 312, the system then applies the patient's specific benefits profile to determine financial responsibility between the patient and his or her insurance company. The office may then collect some portion of the estimated patient-responsible balance at the time of service, as indicated at 314.

In certain other embodiments, instead of recreating the insurance adjudication process, the system may work directly with any of a number of insurance companies to create estimates. As such, it is not necessary for the system to obtain contracted rates from physicians or provider organizations. It is also not necessary for the system to perform 270/271 transactions through a clearinghouse. Finally, it is also not necessary to independently recreate the various bundling rules used.

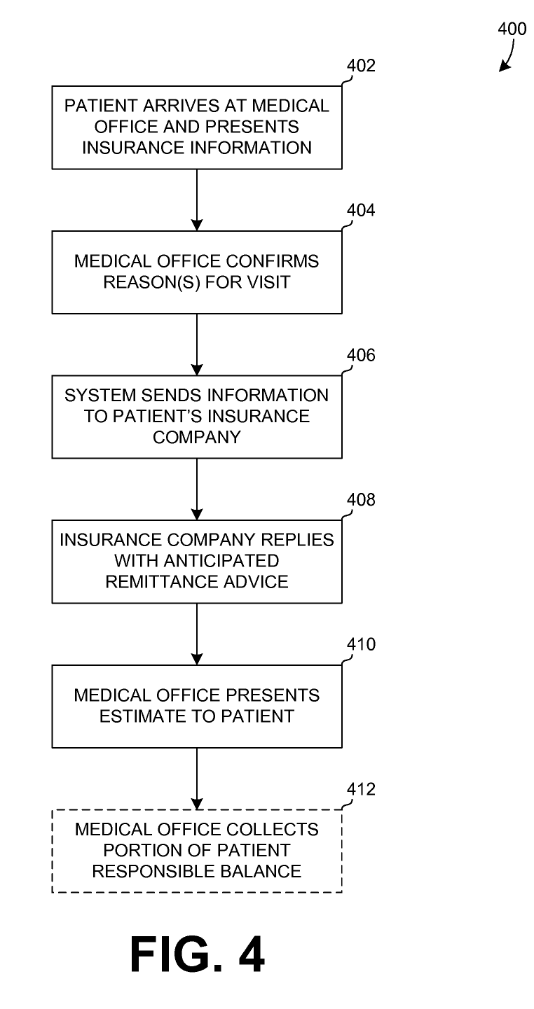

FIG. 4 is a flowchart illustrating a second example 400 of a method of processing payment responsibility information for a patient's appointment at a medical office in accordance with certain embodiments of the disclosed technology. At 402, a patient arrives at a medical office for his or her appointment and presents insurance information to the provider or other office worker or representative. At 404, the office confirms the reason for the visit, which is tied to the most likely bundle of CPTs to be billed for that encounter.

At 406, the system sends directly to the patient's specific insurance company, via an application programming interface (API), at least some of the following pieces of information: the patient's name, member identification, date of birth, rendering physician, and CPT bundle. At 408, using their own adjudication engine, or other processes, the insurance company replies, via an API, with the anticipated remittance advice, which explains repricing, bundling rules, and financial responsibility. At 410, the office presents the estimate to the patient. The office may also opt to collect at least some portion of the patient responsible balance at the time of service, as indicated at 412.

In certain other embodiments, instead of sending patient and anticipated claims information directly to each insurance company involved in a transaction, the system may work with a standard clearinghouse. As such, it is not necessary for the system to establish direct connections with any particular individual insurance companies.

Clearinghouses, by definition, have created legacy EDI connections with nearly all insurance companies. These connections are generally used to route final claims submissions from healthcare providers to payers, as well as a number of other transactions, including delivery of ERAs, visit pre-authorizations, and real-time eligibility requests/responses.

Because of their relative position in the pipeline, clearinghouses generally have access to historic post-adjudication data from all of the payers they have connected to and, therefore, they typically have insight into the contracted rates between specific providers and payers, as well as to the bundling rules used by different payers.

Most clearinghouses themselves have constructed adjudication engines to pre-edit final claims in search of errors so that providers can correct them before they are submitted to the payers. This is a value-added service clearinghouses offer provider organizations to prevent delayed processing or denial by the payer. Most of the clearinghouses presently offer an estimate tool that allows provider customers to enter the patient's insurance information and expected CPTs to be billed.

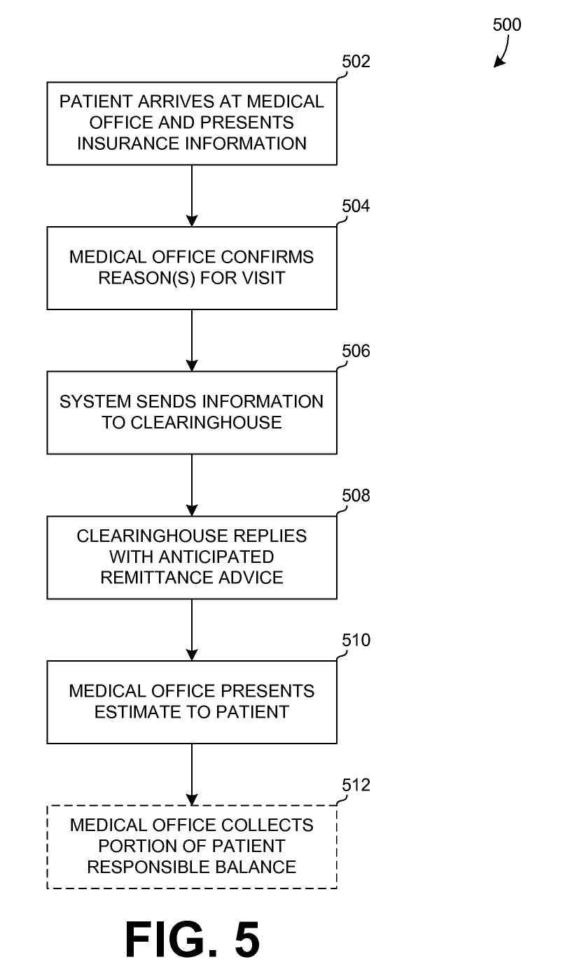

FIG. 5 is a flowchart illustrating a third example 500 of a method of processing payment responsibility information for a patient's appointment at a medical office in accordance with certain embodiments of the disclosed technology. At 502, a patient arrives at a medical office for his or her appointment and presents insurance information to the provider or other office worker or representative. At 504, the office confirms the reason for the visit, which is tied to the most likely bundle of CPTs to be billed for that encounter.

At 506, the system sends directly to a clearinghouse, via an application programming interface (API) at least some of the following pieces of information: the patient's name, insurance provider, member identification, date of birth, rendering physician, and CPT bundle. At 508, using their own adjudication engine or estimation application, or other processes, the clearinghouse replies, via an API, with the patient's current benefits and eligibility status and the anticipated remittance advice, which explains repricing, bundling rules, and financial responsibility. At 510, the office presents the estimate to the patient. The office may also opt to collect at least some portion of the patient responsible balance at the time of service, as indicated at 512.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated.

In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments that are described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A method for processing payment responsibility information for a patient receiving medical care at a medical office, comprising:
the patient presenting insurance information to the medical office where the patient is to receive the medical care;
the medical office entering or confirming initial patient information;
the medical office confirming a reason for the patient's visit;
repricing the medical office's charged amount to reflect a contract allowed amount based on contracted rates with a payer for the medical office;
applying bundling rules of the payer to determine a final allowed amount; and
applying the patient's specific benefits profile to determine a financial responsibility between the patient and his or her insurance company.

2. The method of claim 1, further comprising the medical office collecting at least a portion of the estimated patient-responsible balance at the time of service.

3. The method of claim 1, wherein the initial patient information includes at least some of the following: patient's name, payer information, and patient insurance policy number.

4. The method of claim 1, further comprising performing a 270/271 transaction to determine current status and benefits information for the patient based on the initial patient information.

5. The method of claim 1, wherein the reason for the patient's visit is tied to the most likely bundle of CPTs to be billed for that encounter.

6. A method for processing payment responsibility information for a patient receiving medical care at a medical office, comprising:
the patient presenting insurance information to the medical office where the patient is to receive the medical care;
the medical office confirming a reason for the patient's visit;
using an application programming interface (API), sending initial patient information directly to the patient's insurance company;
using an adjudication engine or other process, the insurance company replying with anticipated remittance advice including an estimate, wherein the anticipated remittance advice explains repricing, bundling rules, and financial responsibility; and
the medical office presenting the estimate to the patient.

7. The method of claim 6, further comprising the medical office collecting at least a portion of the patient-responsible balance at the time of service.

8. The method of claim 6, wherein the initial patient information includes at least some of the following: patient's name, member identification, date of birth, rendering physician, and CPT bundle.

9. The method of claim 6, wherein the reason for the patient's visit is tied to the most likely bundle of CPTs to be billed for that encounter.

10. A method for processing payment responsibility information for a patient receiving medical care at a medical office, comprising:
the patient presenting insurance information to the medical office where the patient is to receive the medical care;
the medical office confirming a reason for the patient's visit;
using an application programming interface (API), sending initial patient information directly to a clearinghouse;
using an adjudication engine or other process, the clearinghouse replying with anticipated remittance advice including an estimate, wherein the anticipated remittance advice explains repricing, bundling rules, and financial responsibility; and
the medical office presenting the estimate to the patient.

11. The method of claim 10, further comprising the medical office collecting at least a portion of the patient-responsible balance at the time of service.

12. The method of claim 10, wherein the initial patient information includes at least some of the following: patient's name, member identification, date of birth, rendering physician, and CPT bundle.

13. The method of claim 10, wherein the reason for the patient's visit is tied to the most likely bundle of CPTs to be billed for that encounter.
